(19) United States
(12) Patent Application Publication
(10) Pub. No.: US 2005/0109921 A1
(43) Pub. Date: May 26, 2005

(54) Alignment method for photoelectric element of photoelectric device with optical fiber

(75) Inventor: Wien-Haurn Ku, Taoyuan County (TW)

Correspondence Address: BIRCH STEWART KOLASCH & BIRCH, PO BOX 747, FALLS CHURCH, VA, 22040-0747, US

(73) Assignee: Delta Electronics, Inc.

(21) Appl. No.: 10/994,472

(22) Filed: Nov. 23, 2004

(30) Foreign Application Priority Data
Nov. 25, 2003 (TW) 92133021

(51) Int. Cl. G01J 5/08

(52) U.S. Cl. 250/227.11; 250/491.1; 385/52

(57) ABSTRACT

An alignment method for photoelectric element of a photoelectric device with an optical fiber includes the following steps. Preliminarily aligning the photoelectric element with the optical fiber, and fixing one of them. Transmitting light into the photoelectric device to reach the photoelectric element via the optical fiber. Detecting the energy amount or optical power of the light leaving the photoelectric element. Adjusting the position of the other one of the photoelectric element and optical fiber until the energy amount or optical power of the light reach a specific value.

### BACKGROUND OF THE INVENTION

(a) Field of the Invention

The invention relates to an alignment method and, more particularly, to an alignment method for a photoelectric element in relation to an optical fiber.

(b) Description of Related Art

A photoelectric transceiver/receiver generally includes photoelectric elements such as a light source and a sensor, a driver, and a post-amplifier. The light source is subsequently driven by an electric signal to generate a light signal, and the sensor receives the light signal and converts it into the electric signal. A photoelectric device, such as a wave-guide type wavelength multiplexing optical transmitter/receiver module, has been disclosed in U.S. Pat. No. 6,480,647. The light source may be laser diodes (LD), light emitting diodes (LED), or vertical cavity surface emitting lasers (VCSEL), and the sensor may be photodiodes (PD).

To ensure that the light emitted by a photoelectric device is accurately transmitted via a coupled optical fiber, and that the light exited from the coupled optical fiber is precisely received by a sensor, alignment of the light source/sensor of the photoelectric transceiver with the coupled optical fiber is crucial. In other words, the light source/sensor can exactly align itself with the optical fiber only as the light source/sensor is precisely located on the optical axis of the photoelectric device.

FIG. 1 shows the alignment of a photoelectric element 12 of a photoelectric transceiver 1 with an optical fiber 4. The photoelectric transceiver 1 includes a fiber connector 11 and a photoelectric element 12. The photoelectric element 12 including an LD 121 as a light source, a condensing lens 122, and two TO package legs 123 is packaged by a metal can (commonly referred to as TO package). For example, the photoelectric transceiver 1 may be a transmitting optical sub-assembly (TOSA) or a receiving optical sub-assembly (ROSA).

Alignment steps of the photoelectric element 12 are described below.

First, the photoelectric element 12 is placed on a platform 3, and the two TO package legs 123 of the photoelectric element 12 are connected to a power supply 2. Then, the fiber connector 11 is fixed on the photoelectric element 12, and two ends of the optical fiber 4 are respectively connected to the fiber connector 11 and an optical power meter 5. The optical power meter 5 is used to measure optical power of the light that is emitted from the LD 121 and passes through the optical fiber 4 and the condensing lens 122. Subsequently, the platform 3 is moved to allow the optical power measured by the optical power meter 5 to reach a maximum, and, at that time, adhesive 6 is filled into the gap between the fiber connector 11 and the photoelectric element 12 to hold the photoelectric element 12 in position.

However, since the diameter of the light beam emitted from the photoelectric element 12, approximately 9 to 10 μm, is very small, the alignment of the photoelectric element 12 with the optical fiber 4 is time-consuming, laborious, and also liable to result in an alignment error.

FIG. 2 shows the alignment of a semiconductor laser chip 13 of a photoelectric transmitting device 10 with an optical fiber 14, where the photoelectric transmitting device 10 is constructed as a planar light wave-guide type device. Referring to FIG. 2, the substrate 101 of the photoelectric transmitting device 10 is patterned to form an electrode 102 on its part surface area on the optical axis 15, and an alignment mark 103 surrounding the electrode 102 is also provided. Further, an alignment mark 131 corresponding to the alignment mark 103 is formed on the bottom surface of the semiconductor laser chip 13. When an infrared light source 20 and an infrared sensor 21 are installed on the opposite sides of the photoelectric transmitting device 10, the semiconductor laser chip 13 and the electrode 102 can be precisely aligned with each other through infrared detection.

However, since the patterning process is complicated and difficult to control in manufacturing precision, it is easy to have products with poor alignment. Besides, the pattern modification due to the change of alignment positions and the infrared equipment for detection are costly.

### BRIEF SUMMARY OF THE INVENTION

Therefore, an object of the invention is to provide an alignment method for a photoelectric element with an optical fiber having simple operation and high accuracy.

Another object of the invention is to provide an alignment method for a photoelectric element with an optical fiber to reduce the manufacturing cost of a photoelectric device.

According to the design of the invention, an alignment method comprises the steps of: fixing one of the photoelectric element and the optical fiber and preliminarily aligning the photoelectric element with the optical fiber; transmitting light via the optical fiber to reach a light receiving/transmitting side surface of the photoelectric element, wherein the wavelength of the input light is smaller than or equal to the wavelength of an luminescence of the photoelectric element; detecting the energy amount or optical power of an output light coming from the light transmitting/receiving side surface of the photoelectric element, wherein a photosensor such as an optical power meter is used for detection; adjusting the position of the other one of the photoelectric element and optical fiber until the energy amount or optical power of the light reach a specific value, and then fixing the other one of the photoelectric element and the optical fiber. The specific value may be a maximum or minimum of the energy amount detected by the photosensor, or may be equal to the energy amount of the luminescence of the photoelectric element. The photoelectric element and the optical fiber are fixed through an adhesive gel.

In another embodiment, the alignment method may further comprise the steps of detecting that whether the light reflected from the light receiving/transmitting side surface of the photoelectric element comprises the luminescence of the photoelectric element by means of a beam splitting element; and adjusting the position of the other one of the photoelectric element and the optical fiber to have the light contain the luminescence of the photoelectric element.

In addition, the light may propagate along different paths after encountering the photoelectric element through an optical path switching element such as a coupler and a bi-refringent crystal.

Furthermore, the photoelectric element is a semiconductor laser element such as a laser diode (LD), a vertical cavity surface emitting laser (VCSEL), a light emitting diode (LED) and a photodiode (PD). The photoelectric device may be a device such as a photoelectric transceiver having a transmitting optical sub-assembly (TOSA) and a receiving optical sub-assembly (ROSA), and a planar light wave-guide photoelectric transmitting device.

The subject invention offers the benefits of having a simpler design for reducing manufacturing loading, shortening manufacturing process for elevating manufacturing efficiency, and performing the alignment with a high accuracy.

### BRIEF DESCRIPTIONS OF THE DRAWINGS

FIG. 1 shows a schematic view illustrating the alignment of a photoelectric element 12 of a conventional photoelectric device with an optical fiber.

FIG. 2 shows a schematic view illustrating the alignment of a semiconductor laser chip in a conventional planar light wave-guide photoelectric transmitting device with an optical fiber.

FIG. 3 is a perspective view showing the coupling of a laser diode (LD) and an optical fiber.

FIG. 4A is a schematic view illustrating the alignment of a photoelectric element in a photoelectric device with an optical fiber according to an embodiment of the invention.

FIG. 4B is a flowchart illustrating the steps of aligning a photoelectric element in a photoelectric device with an optical fiber according to an embodiment of the invention.

FIG. 5 is a schematic view illustrating the alignment of a photoelectric element in a photoelectric device with an optical fiber according to another embodiment of the invention.

FIG. 6 is a schematic view illustrating the alignment of a photoelectric element in a planar light wave-guide device with an optical fiber according to another embodiment of the invention.

FIG. 7 is a schematic view illustrating the alignment of a photoelectric element in a light outputting device with an optical fiber according to another embodiment of the invention.

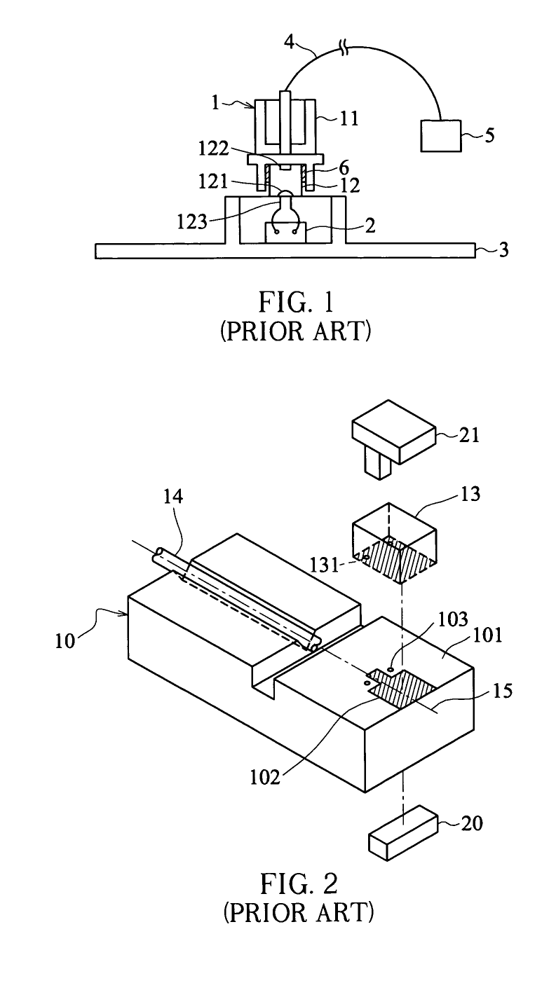

### DETAILED DESCRIPTIONS OF THE INVENTION

When light reflects off a medium, the ratio of the intensity of reflection light to that of the incoming light depends on the refractive index or reflective index of the medium. Accordingly, since different mediums have their respective refractive index, reflective index, dielectric constant, and magnetoconductivity, with the refractive index and reflective index being associated with the dielectric constant and magnetoconductivity, the reflection intensity of the light varies as it illuminates different mediums. On the other hand, when the wavelength of an input light wave is smaller than that of the luminescence of a photoelectric element, the photoelectric element may emit the luminescence having energy amount equal to the energy difference from an electronic excited state to a ground state.

According to the aforesaid phenomena, a simpler method is proposed for aligning a photoelectric element of a photoelectric device with an optical fiber.

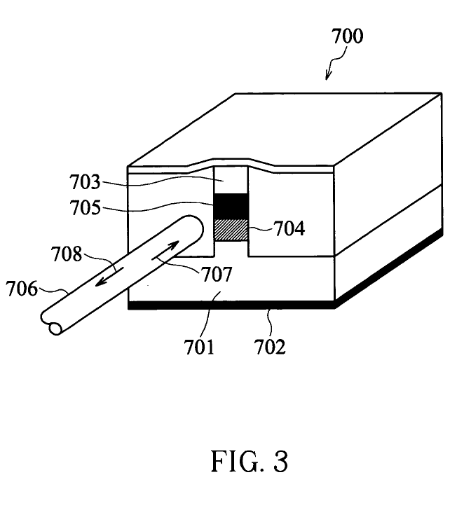

Referring to FIG. 3, for example, an LD 700 includes a substrate 701, a metal film 702, an upper cladding layer 703, a lower cladding layer 704 and a light receiving/transmitting layer 705. The substrate 701, the metal film 702, the upper cladding layer 703 and the lower cladding layer 704 together form a non-light receiving/transmitting area. The LD 700 is coupled with an optical fiber 706 at the light receiving/transmitting area 705, and reflective index of the light receiving/transmitting area 705 is different from that of the upper cladding layer 703 and the lower cladding layer 704 (non-light receiving/transmitting area). Therefore, as light 707 enters the LD 700, different energy intensities of its reflection light 708 reflected at the light receiving/transmitting area 705 and other areas are provided. In that case, we can make sure that the light 707 precisely illuminates the light receiving/transmitting area 705 without illuminating other areas of material layers when the energy amount or optical power of the light 708 reach a maximum or a minimum. Further, the energy amount or optical power of the light 708 reach the maximum as the reflectivity of the light receiving/transmitting area is larger than that of the non-light receiving/transmitting area, while the minimum as the reflectivity of the light receiving/transmitting area is smaller than that of the non-light receiving/transmitting area.

Furthermore, in case of the wavelength of the light 707 being smaller than that of the luminescence from the LD 700, the light receiving/transmitting area 705 will emit the luminescence as the light 707 illuminates the light receiving/transmitting area 705. Thus, the light 708 must contain the luminescence that is separated therefrom to form an individual luminescence wave, and the energy amount of the light 708 may be all contributed by that luminescence.

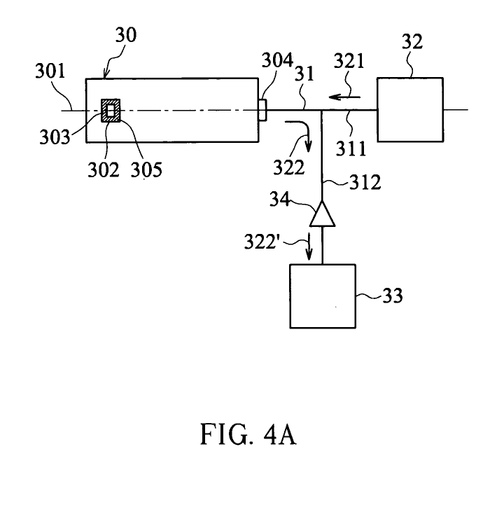

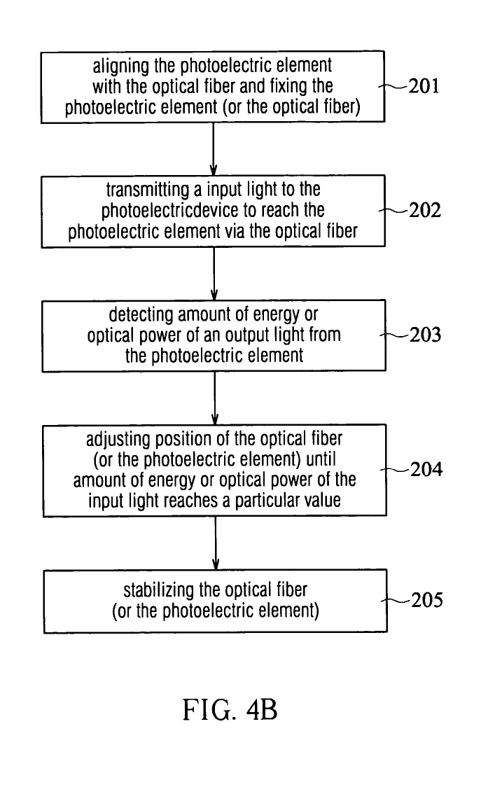

FIGS. 4A and 4B illustrates an alignment method for photoelectric element 303 of a photoelectric device 30 with an optical fiber 31 according to an embodiment of the invention. The photoelectric element 303 may be a laser diode (LD), a vertical cavity surface emitting laser (VCSEL), a light emitting diode (LED), or a photodiode (PD). The alignment method includes steps as described below.

Step 201: Fix either the photoelectric element or the optical fiber and preliminarily align the non-fixed element with the fixed one. For example, in this embodiment, a photoelectric element 303 is placed on an alignment area 302 formed on an optical axis 301 of the photoelectric device 30, and an optical fiber 31 is coupled to a fiber coupling end 304 of the photoelectric device 30 and then fixed. Thus, the photoelectric element 303 is roughly aligned with the optical fiber 31. Further, the optical fiber 31 is arranged to create a first optical path 311 and a second optical path 312, where the former leads to a light source 32 and the latter leads to a photosensor 33. The photosensor 33 may be an optical power meter.

Step 202: Transmit light to a photoelectric element and have the light reach its receiving/transmitting side surface via the optical fiber. For example, in this embodiment, light 321 emitted from the light source 32 enters the photoelectric device 30 and illuminates the photoelectric element 303 after propagating along the first optical path 311 of the optical fiber 31 and passing through the fiber coupling end 304. In case of the wavelength of the input light 321 being equal to that of the luminescence of the photoelectric element 303, the input light 321 reflected at the light receiving/transmitting side surface will have an extreme value of energy amount, namely a maximum or minimum, as long as the optical fiber 31 is precisely aligned with the photoelectric element 303. On the other hand, in case of the wavelength of the input light 321 being smaller than that of the luminescence, as long as the optical fiber 31 is precisely aligned with the photoelectric element 303, the energy level of the photoelectric element will promote to an excited state from a ground state and then decay to the ground state, resulting in the emission of the luminescence. Hence, the energy amount of the reflected light may encompass the specific energy of the luminescence.

Step 203 : Detect the energy amount or optical power of the light leaving the photoelectric element. When the optical fiber 31 is precisely aligned with the photoelectric element 303, the light 321 reflected at the light receiving/transmitting side surface are converted to output light 322 that exits from the photoelectric device 30 and has an extreme value of energy. In that case, a photosensor 33 is used for detecting the energy amount or optical power of the output light 322 leaving the photoelectric element 303 and propagating along the second optical path 312 of the optical fiber 31. The photosensor 33 may be an optical power meter. On the other hand, in case of the wavelength of the input light 321 being smaller than that of the luminescence of the photoelectric element 303, as long as the optical fiber 31 is precisely aligned with the photoelectric element 303, the output light 322 may contain the luminescence of the photoelectric 303. Hence, except that the photosensor 33 is used to detect the energy amount or optical power of the output light 322 leaving the photoelectric element 303 and propagating along the second optical path 312 of the optical fiber 31, an beam splitting element 34 may be further provided to detect whether the output light 322 contains the luminescence of the photoelectric element 303. This may help to ensure the accuracy of the alignment of the optical fiber 31 with the photoelectric element 303. Hence, we may use only the photosensor 33 to detect the energy amount or optical power of the output light 322. Alternatively, we may first use the beam splitting element 34 to split the output light 322 and then use the photosensor 33 to receive the split light 322′, and further determine whether the wavelength and energy amount of the split light 322′ are equal to those of the luminescence of the photoelectric element 303.

Step 204 : Adjust the position of the photoelectric element and the optical fiber until the energy amount or optical power of the input light reach a specific value. In this embodiment, the optical fiber 31 may be first fixed and then the position of the photoelectric element 303 is adjusted relating to that of the optical fiber 31 until the energy amount or optical power of the output light 322 from the photoelectric element 303 reach an extreme value (maximum or minimum) or the value equal to that of the luminescence of the photoelectric element 303. Alternatively, the photoelectric element 303 may be first fixed and then the position of the optical fiber 31 is adjusted relating to that of the optical fiber 31. In addition, the beam splitting element 34 may be used to split the output light 322, and either of the photoelectric element or optical fiber is adjusted in its position until the output light 322 contains the luminescence of the photoelectric element 303.

Step 205 : Hold the photoelectric element and the optical fiber in position. For instance, the optical fiber 31 may be first fixed and then adhesive gel 305 is filled into a gap between the photoelectric element 303 and the alignment area 302 to affix the photoelectric element 303 to the optical fiber 31.

In the invention, the first optical path 311 and the second optical path 312 derived from the optical fiber 31 are realized by providing an optical path switching element (not shown), which may be a coupler or a bi-refringent crystal.

In the invention, a lens (not shown) may also be added to perform the alignment of the lens, the photoelectric element and the optical fiber. In the accomplishment, two of the three elements are first fixed, and the remaining element is located using the aforesaid method, as will be described below.

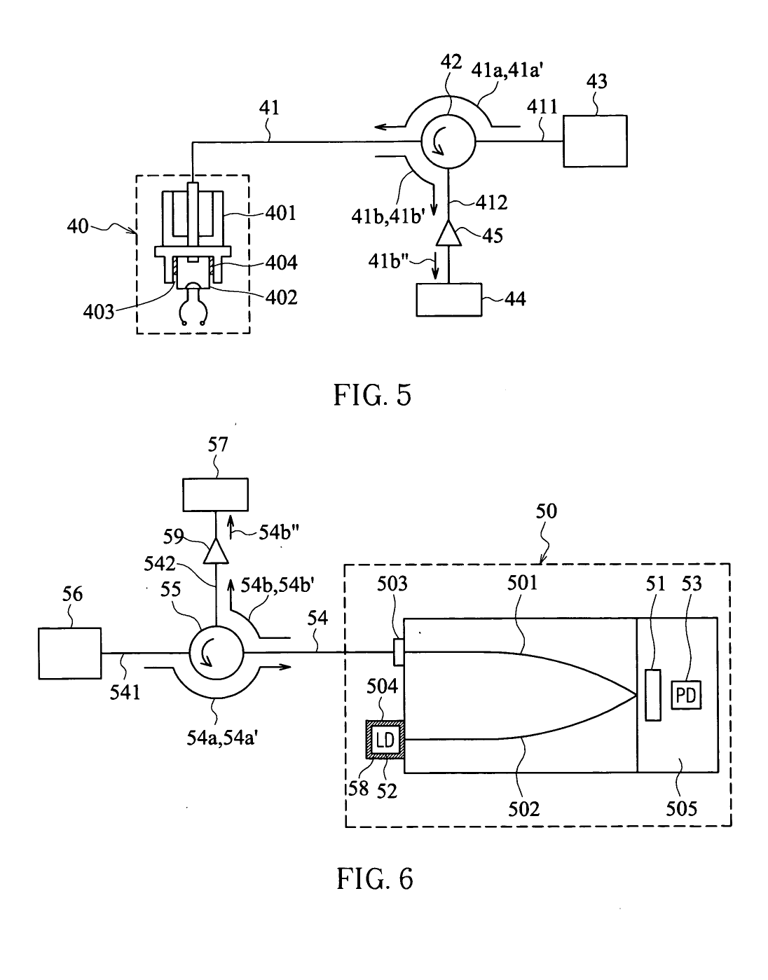

Referring to FIG. 5, the alignment method for photoelectric element of a photoelectric device with an optical fiber is applied to a photoelectric transmitting device 40. The photoelectric transmitting device 40 in this embodiment includes a fiber connector 401, a photoelectric element 402 and an alignment area 403. The photoelectric element 402 includes a light source, which may be an LD, a VCSEL or an LED.

The alignment method according to this embodiment includes the following steps.

The photoelectric element 402 is first placed on the alignment area 403 under the fiber connector 401. Two ends of an optical fiber 41 are respectively connected to the fiber connector 401 and an optical path switching element 42. The two optical fibers 411 and 412 is connected to the optical switching element 42 at their ends, while the other ends of them are respectively connected to a light source 43 and a photosensor 44. The photosensor 44 may be an optical power meter. In this embodiment, the optical path switching element 42 unidirectionally conducts the optical fiber 411 and the optical fiber 41, or the optical fiber 412 and the optical fiber 41. The optical path switching element 42 may be a coupler or a bi-refringent crystal.

A light source 43 output light 41a having wavelength equal to that of the luminescence of the photoelectric element 402, and then the light 41 a illuminates the photoelectric transmitting device 40 via the optical fibers 411 and 41.

The photosensor 44 is utilized to detect energy amount or optical power of the light 41b reflected from the photoelectric element 402 and traveling through the optical fibers 41 and 412. The position of the photoelectric element 402 is adjusted until the energy amount or optical power of the reflected light 41b detected by the photosensor 44 reaches a maximum or a minimum. Then, the photoelectric element 402 is affixed to the connector 401, with its periphery on the alignment area being applied with adhesive glue 404.

Furthermore, this embodiment may also be implemented according to the other aspect of the invention described above.

The photoelectric element 402 is placed on the alignment area 403 under the fiber connector 401. Two ends of an optical fiber 41 are respectively connected to a fiber connector 401 and an optical path switching element 42. One end of each of two optical fibers 411 and 412 is connected to the optical switching element 42, while the other ends of them are respectively connected to a light source 43, a photosensor 44 and a beam splitting prism 45. The optical path switching element 42 unidirectionally conducts the optical fiber 411 and the optical fiber 41, or the optical fiber 412 and the optical fiber 41. The optical path switching element 42 may be a coupler or a bi-refringent crystal.

Light 41a′ having wavelength smaller than that of the luminescence of the photoelectric element 402 is outputted from the light source 43, and illuminates the photoelectric transmitting device 40 via the optical fibers 411 and 41.

The light 41b′ is split using the beam splitting beam 45, and the light 41b″ split from the beam splitting prism 45 is received by the photosensor 44 to determine whether the energy amount of the light 41b″ approximates or equals the energy amount of the luminescence of the photoelectric element 402. Alternatively, the photosensor 44 may directly receive the light 41′ to omit the beam splitting prism 45.

The position of the photoelectric element 402 is adjusted until the wavelength of the light 41b″ approximates or equals that of the luminescence of the photoelectric element 402, or until the energy amount of the light 41b reaches a maximum or a minimum.

Then, the photoelectric element 402 is affixed to the connector 401, with its periphery on the alignment area being applied with adhesive glue 404.

Referring to FIG. 6, the alignment method for photoelectric element of a photoelectric device with an optical fiber according to the invention is applied to a planar light wave-guide device 50. As shown in FIG. 6, the planar light wave-guide device 50 includes a first wave-guide circuit 501, a second wave-guide circuit 502, a fiber coupling end 503, a filter 51,an LD 52 and a PD 53.

In this embodiment, the LD 52 and the PD 53 need to be aligned. The alignment method of the LD 52 is described below.

First, on the light wave-guide circuit 502 of the planar wave-guide device 50, a recess 504 slightly larger than the LD 52 is provided on an optical axis to receive the LD 52. Two ends of an optical fiber 54 are respectively coupled to a coupling end 503 of the planar wave-guide device 50 and an optical path switching element 55. One end of each of two optical fibers 541 and 542 is connected to the optical path switching element 55, and the other ends of them are respectively connected to a light source 56 and a photosensor 57. The photosensor 57 may be an optical power meter. In this embodiment, the optical path switching element 55 unidirectionally conducts the optical fiber 541 and the optical fiber 54 (served as a first optical path), or the optical fiber 542 and the optical fiber 54 (served as a second optical path). The photosensor 57 may be a coupler or a bi-refringent crystal.

A light source 56 inputs light 54a having wavelength not equal to that of an luminescence of the LD 52 to illuminate the device 50 via the optical fibers 541 and 54, and then the light 54a travels along the first wave-guide circuit 501. Since the filter 51 is designed to allow a light having wavelength equal to that of the luminescence of the LD 52 to pass through, the light 54a continues to travel toward the LD 52 along the second wave-guide circuit 502 after it encounters the filter 51. Then, the light 54a is reflected by the LD 52 and back to the original wave-guide circuit.

A photosensor 57 is used to detect the energy amount or optical power of the light 54b reflected by the LD 52. The position of the LD 52 is adjusted until the energy amount or optical power of the light 54b detected by the photosensor 57 reaches a maximum or minimum. Then, Adhesive gel 58 is filled into a gap between the LD 52 and the recess 504 to fix the LD 52.

Similarly, alignment of the PD 53 may be implemented by using the aforesaid method, with the only difference being that the wavelength of the input light 54a is necessarily equal to that of the luminescence of the PD 53. Thereby, the input light 54a will pass through the filter 51 to reach the PD 53 and be further reflected.

Also, this embodiment may be implemented according to another way as described below.

First, on the light wave-guide circuit 502 of the planar wave-guide device 50, a recess 504 slightly larger than the LD 52 is provided on an optical axis to receive the LD 52. Two ends of an optical fiber 54 are respectively coupled to a coupling end 503 of the planar wave-guide device 50 and an optical path switching element 55. One end of each of two optical fibers 541 and 542 is connected to the optical path switching element 55, and the other ends of them are respectively connected to a light source 56, a photosensor 57 and a beam splitting prism 59. Herein, the optical path switching element 55 unidirectionally conducts the optical fiber 541 and the optical fiber 54 (served as a first optical path), or the optical fiber 542 and the optical fiber 54 (served as a second optical path). The photosensor 57 may be a coupler or a bi-refringent crystal.

A light source 56 inputs light 54a′ having wavelength smaller then that of an luminescence of the LD 52 to illuminate the device 50 via the optical fibers 541 and 54, and then the light 54a′ travels along the first wave-guide circuit 501. Since the filter 51 is designed to allow a light having wavelength equal to that of the luminescence of the LD 52 to pass through, the light 54a′ continues to travel toward the LD 52 along the second wave-guide circuit 502 after it encounters the filter 51. Then, the light 54a′ is reflected by the LD 52 and back to the original wave-guide circuit.

Then, the light 54b′ is split using the beam splitting prism 59, and the split light 54b″ from the beam splitting prism 59 is received by the photosensor 57 to determine whether the energy amount of the light 54b″ approximates or equals that of the luminescence of the LD 52. Alternatively, the photosensor 57 may directly receive the light 54b′ to omit the beam splitting prism 59.

The position of the LD 52 is adjusted until the wavelength of the light 54b″ approximates or equals that of the luminescence of the LD 52, or until the energy amount of the light 54b″ reaches a maximum or minimum.

Then, an adhesive glue 58 is filled in the gap between the LD 52 and the recess 504 to fix the LD 52.

Similarly, alignment of the PD 53 may be implemented by using the aforesaid method, with the only difference being that the wavelength of the input light 54a′ is necessarily equal to a value within the range of a cut-off wavelength for the filter 51 to be capable of passing through the filter 51. Thereby, the input light 54a′ will pass through the filter 51 to reach the PD 53.

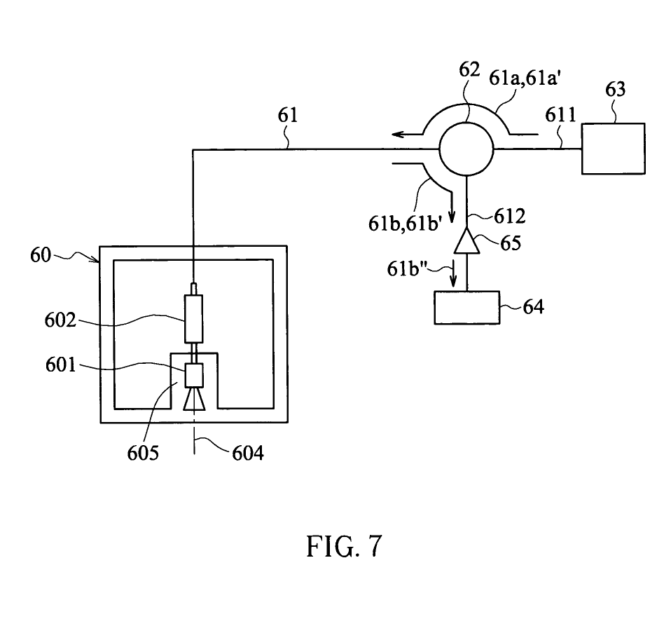

Referring to FIG. 7, an alignment method for photoelectric element of a photoelectric device with an optical fiber is applied to a light outputting device 60. As shown in FIG. 7, the light outputting device 60 includes a photoelectric element 601, a rod GRIN lens 602 and an optical fiber 61. The photoelectric element 601 may be an LED. The alignment method according to this embodiment is described below.

First, the rod GRIN lens 602 is fixed on an optical axis 604 of the light outputting device 60. At the coupling end of the light outputting device 60 and the rod GRIN lens 602, an alignment area 605 located on the optical axis 604 is provided. The photoelectric element 601 is placed on the alignment area 605.

The optical fiber 61 is coupled with the rod GRIN lens 602 and then fixed. One end of the optical fiber 61 is provided with an optical path switching element 62, and two optical fibers 611 and 612, which are respectively installed with a light source 63 and a photosensor 64 at their ends, are drawn out from the optical path switching element 62. In this embodiment, the optical path switching element 62 unidirectionally conducts the optical fiber 61 and the optical fiber 611 (served as a first optical path), or the optical fiber 61 and the optical fiber 612 (served as a second optical path). The photosensor 57 may be a coupler or a bi-refringent crystal.

A light source 63 inputs light 61 a having wavelength equal to that of an luminescence of the photoelectric element 601 to illuminate the light outputting device 60 via the optical fibers 611 and 61. Then, the light 61b reflected by the photoelectric element 601 travels through the optical fibers 61 and 612 and further received by the photosensor 64.

The photosensor 64 is used to detect the energy amount or optical power of the light 61b. The position of the photoelectric element 601 is adjusted until the energy amount or optical power of the light 61b detected by the photosensor 64 reaches a maximum or minimum. Subsequently, the photoelectric element 601 is fixed.

In this embodiment, the alignment for the photoelectric element 601, the optical fiber 61 and the rod GRIN lens 602 may be implemented according to another way described below.

First, the rod GRIN lens 602 is fixed on an optical axis 604 of the light outputting device 60. At the coupling end of the light outputting device 60 and the rod GRIN lens 602, an alignment area 605 located on the optical axis 604 is provided. The photoelectric element 601 is placed on the alignment area 605.

The optical fiber 61 is coupled with the rod GRIN lens 602 and then fixed. One end of the optical fiber 61 is provided with an optical path switching element 62, and two optical fibers 611 and 612, which are installed with a light source 63, a photosensor 64 and a light splitting prism at their ends, are drawn out from the optical path switching element 62. In this embodiment, the optical path switching element 62 unidirectionally conducts the optical fiber 61 and the optical fiber 611 (served as a first optical path), or the optical fiber 61 and the optical fiber 612 (served as a second optical path). The photosensor 57 may be a coupler or a bi-refringent crystal.

A light source 63 inputs light 61a′ having wavelength smaller than that of an luminescence of the photoelectric element 601 to illuminate the light outputting device 60 via the optical fibers 611 and 61. Then, the light 61b′ reflected by the photoelectric element 601 travels through the optical fibers 61 and 612 and further received by the photosensor 64.

The light 61b′ is split using the beam splitting prism 65, and the split light 61b″ received by the photosensor 64 is used to determine whether the energy amount of the light 61b″ approaches or equals that of the luminescence of the photoelectric element 601. Alternatively, the photosensor 64 may directly receive the light 61b′ to omit the beam splitting prism 65.

The position of the photoelectric element 601 is adjusted until the wavelength the light 61b″ equals that of the luminescence of the photoelectric element 601 (the energy amount of the light 61b″ approximates that of the photoelectric element 601), or until the energy amount of the light 61b′ reaches a maximum or minimum. Subsequently, the photoelectric element 601 is fixed.

In this embodiment, the optical fiber 61 and the rod GRIN lens 602 are fixed first, and then the position of the photoelectric element is adjusted relating to the two fixed elements. However, the non-fixed elements in the preliminary arrangement can be any of the three elements. For example, the optical fiber 61 and the photoelectric element 601 may also be fixed first, and then the position of the GRIN lens 602, namely the non-fixed elements, is adjusted relating to the two fixed elements.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

1. An alignment method for a photoelectric element of a photoelectric device with an optical fiber, comprising the steps of:
providing an alignment area on the optical axis of the photoelectric device to set the photoelectric element;
coupling the optical fiber to the photoelectric device;
transmitting light having a wavelength equal to that of the luminescence of the photoelectric element to the photoelectric element via the optical fiber;
detecting the energy amount or optical power of the light leaving the photoelectric element and traveling through the optical fiber;
adjusting the position of the photoelectric element until the optical power or the energy amount of the light reach an extreme value; and
fixing the photoelectric element.

2. The alignment method as recited in claim 1, wherein the photoelectric element has a light receiving/transmitting area and at least one cladding layer, with the reflectivity of the light receiving/transmitting area and that of the cladding layer being different to each other.

3. The alignment method as recited in claim 1, wherein the step of detecting the energy amount or optical power is performed by a photosensor.

4. The alignment method as recited in claim 1, further comprising the step of:
splitting the light by means of a beam splitting element; and
adjusting the position of the photoelectric element until the output light comprises the luminescence of the photoelectric element.

5. The alignment method as recited in claim 4, wherein the beam splitting element is a beam splitting prism or an optical grating.

6. The alignment method as recited in claim 1, wherein the photoelectric element is a semiconductor laser, a light emitting diode (LED) or a photodiode (PD).

7. An alignment method for a photoelectric element of a photoelectric device with an optical fiber, comprising the steps of:
fixing one of the photoelectric element and the optical fiber and preliminarily aligning the photoelectric element with the optical fiber;
transmitting light via the optical fiber to reach a light receiving/transmitting side surface of the photoelectric element;
detecting the energy amount or optical power of the light reflected from the light receiving/transmitting side surface of the photoelectric element;
adjusting the position of the other one of the photoelectric element and the optical fiber until the energy amount or optical power of the light reach a specific value; and
fixing the other one of the photoelectric element and the optical fiber.

8. The alignment method as recited in claim 7, wherein the photoelectric element has a light receiving/transmitting area and at least a non-light receiving/transmitting area, and the specific value is the maximum of the energy amount or optical power of the light as the reflectivity of the light receiving/transmitting area is larger than that of the non-light receiving/transmitting area.

9. The alignment method as recited in claim 7, wherein the photoelectric element has a light receiving/transmitting area and at least a non-light receiving/transmitting area, and the specific value is the minimum of the energy amount or optical power of the light as the reflectivity of the light receiving/transmitting area is smaller than that of the non-light receiving/transmitting area.

10. The alignment method as recited in claim 7, wherein the specific value equals the energy amount of the luminescence of the photoelectric element.

11. The alignment method as recited in claim 10, further comprising the steps of:
detecting that whether the light reflected from the light receiving/transmitting side surface of the photoelectric element comprises the luminescence of the photoelectric element by means of a beam splitting element; and
adjusting the position of the other one of the photoelectric element and the optical fiber until the light comprises the luminescence of the photoelectric element.

12. The alignment method as recited in claim 11, wherein the beam splitting element is a beam splitting prism or an optical grating.

13. The alignment method as recited in claim 7, further comprising the step of providing a lens and making the light pass through the lens before reaching the light receiving/transmitting side surface of the photoelectric element.

14. The alignment method as recited in claim 7, further comprising the step of providing an optical path switching element to have the light propagate along different paths.

15. The alignment method as recited in claim 14, wherein the optical path switching element is a coupler or a bi-refringent crystal.

16. The alignment method as recited in claim 7, wherein the step of detecting the energy amount or optical power of the light is performed by a photosensor.

17. The alignment method as recited in claim 16, wherein the photosensor is an optical power meter.

18. The alignment method as recited in claim 7, wherein the photoelectric element is a semiconductor laser, an LED or a PD.

19. The alignment method as recited in claim 7, wherein the step of fixing the other one of the photoelectric element and the optical fiber is performed by an adhesive gel.

20. The alignment method as recited in claim 7, wherein the photoelectric device is a photoelectric transceiver, a planar light wave-guide photoelectric transmitting device, or a light outputting device.

21. An alignment method for a photoelectric element of a photoelectric device with an optical fiber, comprising the steps of:
providing an alignment area on the optical axis of the photoelectric device to set the photoelectric element;
coupling the optical fiber to the photoelectric device;
transmitting light having a wavelength smaller than that of the luminescence of the photoelectric element to the photoelectric element via the optical fiber;
detecting the energy amount or optical power of the light leaving the photoelectric element and traveling through the optical fiber;
adjusting the position of the photoelectric element until the optical power or the energy amount of the light reach an extreme value; and
fixing the photoelectric element.
